(19) United States
(12) Patent Application Publication
(10) Pub. No.: US 2014/0311063 A1
(43) Pub. Date: Oct. 23, 2014

(54) RAIN DEFLECTING WINDOW COVERING

(71) Applicant: Roger Mc Intyre, Lindenhurst, NY (US)

(72) Inventor: Roger Mc Intyre, Lindenhurst, NY (US)

(21) Appl. No.: 13/865,654

(22) Filed: Apr. 18, 2013

(51) Int. Cl. E06B 3/30; E06B 7/10; E06B 7/02

(52) U.S. Cl. CPC E06B 3/30; E06B 7/02; E06B 7/10
USPC 52/203

(57) ABSTRACT

A rain deflecting window covering has a main frame with an interior opening to allow air to flow through. A first expander portion telescopically fits between a first side of the frame and a window and a second expander portion telescopically fits on the opposite side to effectively cover the entire open portion of the window. A rain deflecting cover fits on the exterior side of the frame opening and covers the opening except for an inlet opening at the bottom that faces downward. Rain is directed down the rain deflecting cover and away from the window opening. A series of shutters are placed over the opening to allow a user to control the amount of air allowed to pass through.

### CROSS REFERENCE TO RELATED APPLICATIONS

This application claims priority and herein incorporates by reference U.S. provisional patent application 12/565,676, filed Apr. 18, 2012.

### BACKGROUND OF THE INVENTION

As soon as humans began living in dwellings, openings were used to see outside and to allow fresh air to enter. The openings were covered by furs or other materials to keep the elements out of the dwelling when the conditions became inclement. As glass became cheaper, it became an ideal window covering since it allows light in while keeping the elements out. Open windows allow great air flow, but also allow rain to enter the dwelling as well as insects.

It is known to use a screen to keep out the insects, but generally, the windows need to be closed when it is raining or the rain will inevitably come in through the screen. It is often desirable to have fresh air during humid conditions such as when it is raining, but generally, as discussed above, the windows need to be closed to keep the rain out.

There is a need for an easy to use system that allows fresh air to enter the dwelling during inclement weather while not allowing the precipitation to enter the dwelling.

### SUMMARY OF THE INVENTION

A rain deflecting window covering has a main frame with an interior opening to allow air to flow through. A first expander portion telescopically fits between a first side of the frame and a window and a second expander portion telescopically fits on the opposite side to effectively cover the entire open portion of the window. A rain deflecting cover fits on the exterior side of the frame opening and covers the opening except for an inlet opening at the bottom that faces downward. Rain is directed down the rain deflecting cover and away from the window opening. A series of shutters are placed over the opening to allow a user to control the amount of air allowed to pass through.

Other features and advantages of the instant invention will become apparent from the following description of the invention which refers to the accompanying drawings.

### BRIEF DESCRIPTION OF THE DRAWINGS

FIG. 1 is a perspective view of rain deflecting window covering according to an embodiment of the present invention.

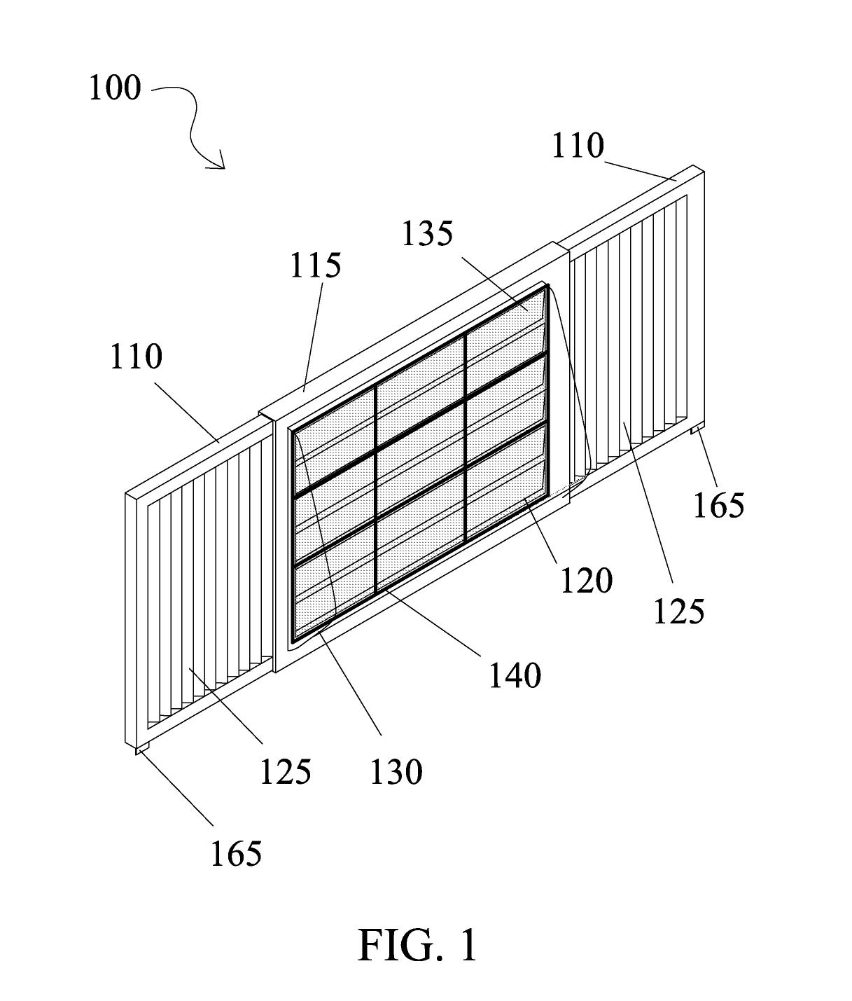

FIG. 2 is a front view of the rain deflecting window covering shown in FIG. 1.

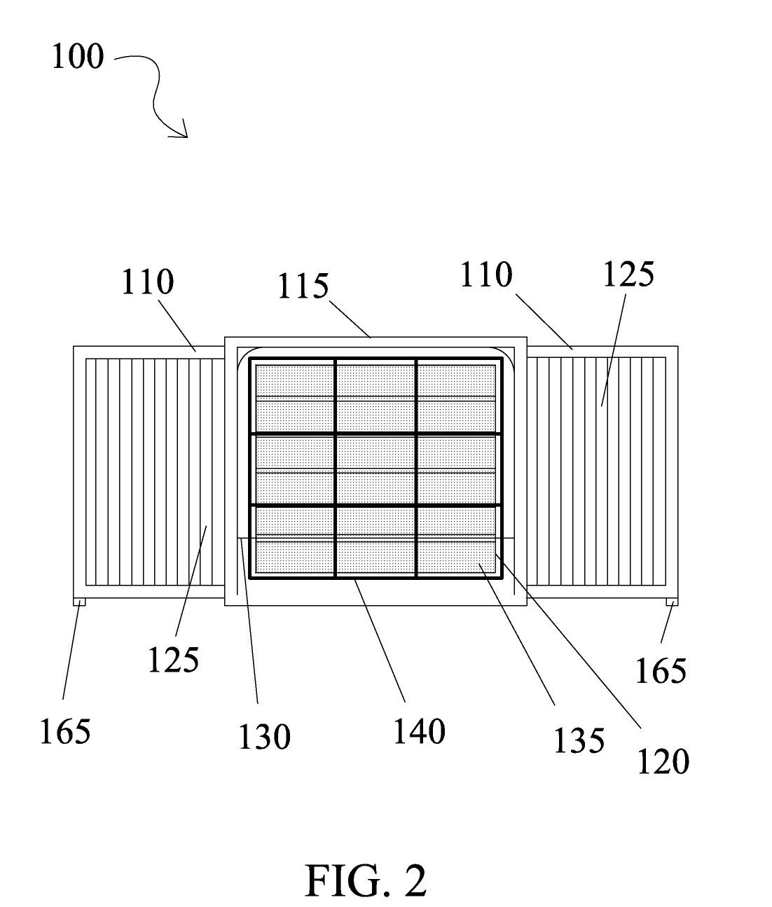

FIG. 3 is a rear view of the rain deflecting window covering shown in FIG. 1.

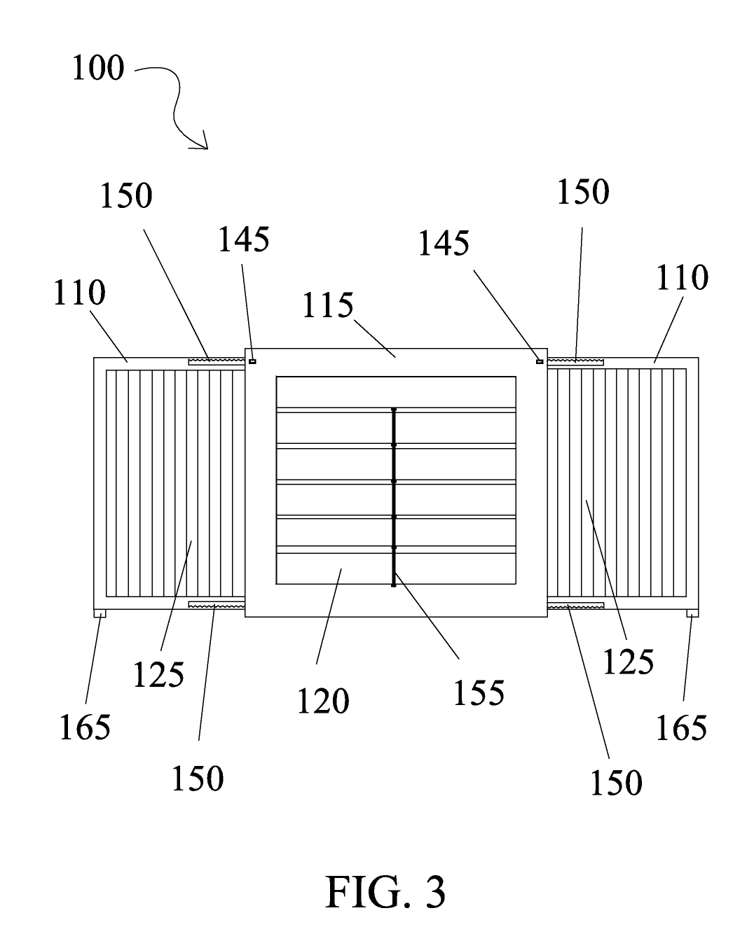

FIG. 4 is a side view of the rain deflecting window covering shown in FIG. 1.

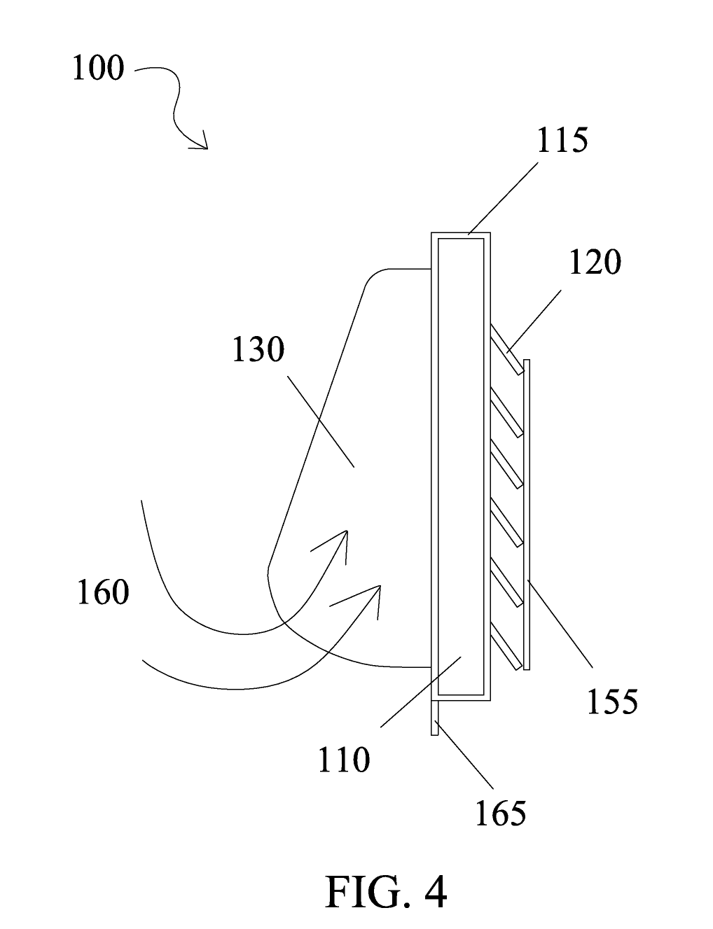

FIG. 5 is a bottom view of the rain deflecting window covering shown in FIG. 1.

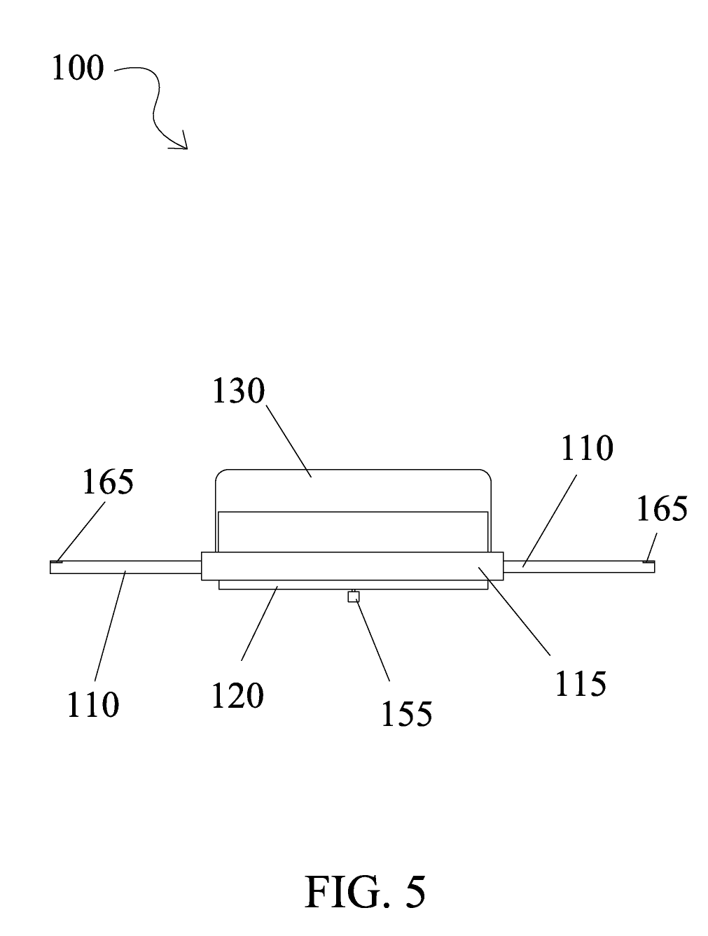

FIG. 6 is a rear view of the rain deflecting window covering shown in FIG. 1.

### DETAILED DESCRIPTION OF THE INVENTION

In the following detailed description of the invention, reference is made to the drawings in which reference numerals refer to like elements, and which are intended to show by way of illustration specific embodiments in which the invention may be practiced. It is understood that other embodiments may be utilized and that structural changes may be made without departing from the scope and spirit of the invention.

Referring to the figures, a rain deflecting window covering 100 is shown having a main frame 115 with two c-frames 110 that telescopically fit within main frame 115 to allow a user to adjust rain deflecting window covering 100 to fit within a window (not shown). As c-frame 110 moves, accordion seal 125 adjusts to seal the window opening. A screen 135 fits over an outside facing portion of main frame 115 to keep insects, leaves etc. from entering the window. A rain deflecting cover 130 keeps rain from entering the window while allowing air to enter. Rain deflecting cover 130 is molded of clear plastic and is sloped to deflect rain away from the opening. Rain deflecting cover 130 encloses the opening in main frame 115 on three sides, top, front and both sides with an opening at the bottom to allow fresh air 160 to enter while blocking rain from entering the window. A pair of leveling tabs 165 are provided to keep c-frames 110 level with main frame 115. Of course rain deflecting cover 130 can be made of other suitable materials and is not required to be clear.

Main frame 115 has an opening to allow air to pass through. To keep insects out, screen 135 is provided to cover the opening in main frame 115 and is held in place with a screen frame 140. Of course other means of attaching screen 135 may be used as long as screen 135 is held securely in place. Screen 135 is removable to allow the user to wash it. To allow the user to control the airflow, a series of shutters 120 are provided and a shutter bar 155 is attached to control shutters 120 as is known in the art. Shutters 120 may be placed in a horizontal position to allow maximum air flow to a vertical position to block the air flow.

An adjuster 145 is provided to selectively allow the user to move c-frames 110 in and out to fit the window space. Adjuster 145 has an engagement ratchet that fits within an adjustment track 150. As the user moves adjuster 145, the ratchet disengages with adjustment track 150 and then released to engage and hold c-frame 110 in the selected position. Of course other adjustment means may be used as long as c-frame 110 is selectively held in place to seal a window such as providing a place to secure c-frame 110 with a screw, hook and loop fasteners, etc., as is known in the art.

In use, the user opens a double sash window and places rain deflecting window covering 100 in the window space and the sash is lowered to hold secure rain deflecting window covering 100. Accordion seals 125 are adjusted to seal the side spaces. The user then adjusts shutters 120 to allow the desired air flow. Rain deflecting cover 130 keeps rain from entering the window while still allowing air to enter.

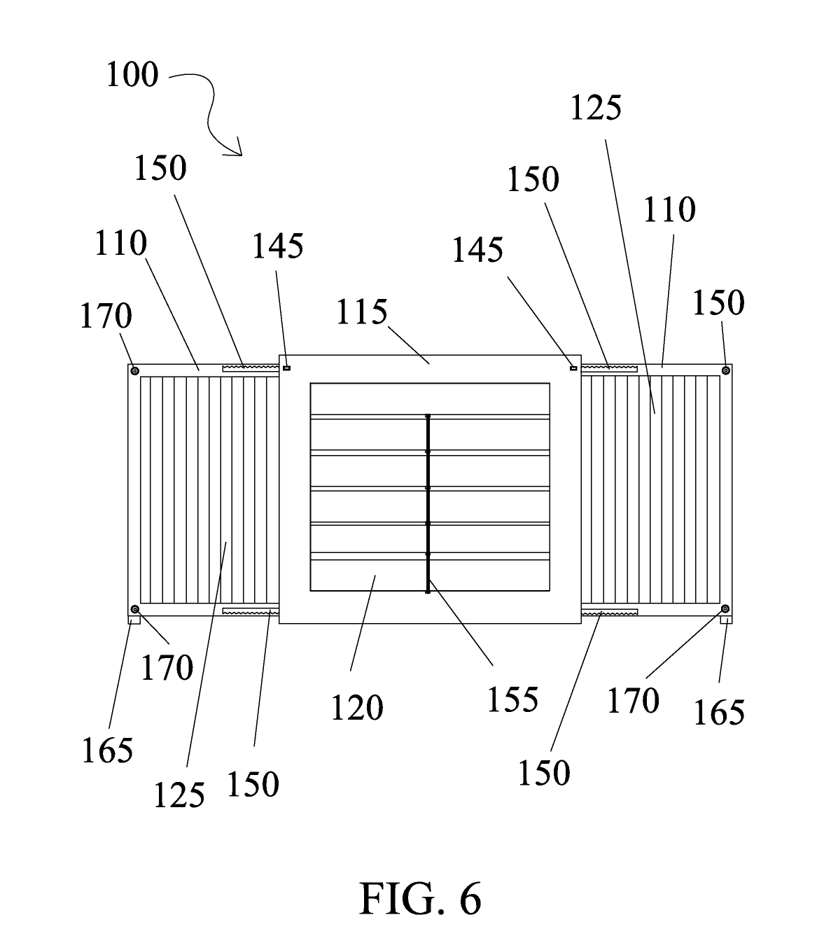

Referring to FIG. 6, a plurality of stops 170 are used to provide a stable portion to retain and position c-frames 110 by resting on a window sill (not shown) to keep the c-frame from moving when installed.

Although the instant invention has been described in relation to particular embodiments thereof, many other variations and modifications and other uses will become apparent to those skilled in the art.

1. A rain deflecting window covering comprising:
a main frame;
a first and second c-frame;
said first and second c-frame having a telescoping portion on opposing sides;
said main frame having a top and bottom portion adapted to receive said telescoping portions;
wherein said telescoping portions are selectively adjustable to seal a side portion of a window;
said main frame having an air opening therein wherein air enters therein;
a rain deflecting cover having a bottom opening wherein air is drawn through said bottom opening; and
said rain deflecting cover disposed over said air opening wherein precipitation is directed away from said opening.

2. The rain deflecting window covering of claim 1 further comprising a screen covering said air opening.

3. The rain deflecting window covering of claim 2 further comprising a plurality of shutters movably disposed over said air opening whereby said air opening is selectively operable between full open position and a full close position.

4. The rain deflecting window covering of claim 1 whereby said rain deflecting cover is substantially clear.

5. The rain deflecting window covering of claim 1 wherein said rain deflecting cover has a top portion integrally formed with two side portions and a sloping front portion adapted to direct water away from a window.

6. A rain deflecting window cover for covering a window to allow outside air to enter while preventing precipitation from entering comprising:
a frame portion adapted to fit over a portion of a window;
said frame portion having an interior air opening adapted to allow air to flow there through;
a first expander portion adapted to fit between said frame portion and an edge of said window;
a second expander portion adapted to fit between said frame portion and an opposite edge of said window;
a rain deflecting cover disposed over an exterior portion of said interior air opening; and
said rain deflecting cover having an open intake portion facing downward wherein water is deflected away from said window.

7. The rain deflecting window cover for covering a window to allow outside air to enter while preventing precipitation from entering according to claim 6 further comprising a screen adapted to cover said interior air opening.

8. The rain deflecting window cover for covering a window to allow outside air to enter while preventing precipitation from entering according to claim 6 further comprising a plurality of shutters movably disposed over said interior air opening whereby said air opening is selectively operable between full open position and a full close position.

9. The rain deflecting window cover for covering a window to allow outside air to enter while preventing precipitation from entering according to claim 6 whereby said rain deflecting cover is substantially clear.

10. The rain deflecting window cover for covering a window to allow outside air to enter while preventing precipitation from entering according to claim 6 wherein said rain deflecting cover has a top portion integrally formed with two side portions and a sloping front portion adapted to direct water away from a window.

11. The rain deflecting window cover for covering a window to allow outside air to enter while preventing precipitation from entering according to claim 6 further comprising:
a first adjustment track disposed along a portion of said first expander portion;
a first adjuster ratchet mechanically connected to said first adjustment track whereby said first expander portion is selectively positionable;
a second adjustment track disposed along a portion of said second expander portion; and
a second adjuster ratchet mechanically connected to said second adjustment track whereby said first expander portion is selectively positionable.

12. The rain deflecting window cover for covering a window to allow outside air to enter while preventing precipitation from entering according to claim 8 further comprising a shutter bar attached to said plurality of shutters whereby said shutters are synchronously moveable.

13. The rain deflecting window cover for covering a window to allow outside air to enter while preventing precipitation from entering according to claim 6 further comprising:
a first stabilizing stop disposed along an outer top edge of said first and second expander portions; and
a second stabilizing stop disposed along a bottom edge of said first and second expander portions wherein said stops rest on a window sill to stabilize said first and second expander portions.

14. The rain deflecting window cover for covering a window to allow outside air to enter while preventing precipitation from entering according to claim 6 wherein said first and second expander portions have a plurality of accordion like panels that fold as they are moved in and out.

15. The rain deflecting window cover for covering a window to allow outside air to enter while preventing precipitation from entering according to claim 7 whereby said screen is removable.
